(19) United States
(12) Patent Application Publication
(10) Pub. No.: US 2010/0262507 A1
(43) Pub. Date: Oct. 14, 2010

(54) METHOD AND ASSEMBLY FOR PRE-SEATING COMMERCIAL ACTIVITY

(75) Inventors: Thomas Woycik, Troy, MI (US); Charles Wheeler, Waterford, MI (US); Kevin Varga, Rochester, MI (US); Jeffrey Breazeale, Waterford, MI (US)

Correspondence Address: REISING ETHINGTON P.C., P O BOX 4390, TROY, MI, 48099-4390, US

(73) Assignee: Nextep Systems, Inc., Troy, MI (US)

(21) Appl. No.: 12/421,882

(22) Filed: Apr. 10, 2009

(51) Int. Cl. G06Q 30/00; G08B 5/36

(52) U.S. Cl. 705/26; 340/286.09

(57) ABSTRACT

A method for ordering goods and services is used in conjunction with a computer-based ordering system that is principally viewed as a kiosk by customers or patrons of a restaurant. The method synchronizes the submission of an order for food preparation to a kitchen with the patrons actually getting a table at which they may sit. This reduces the wait time for the patron, increasing their overall satisfaction with service and reduces the cycle time of a particular table (increases “turns” at the table). The method includes receiving an order for goods or services through the computer-based ordering system to create an order. A queue value, e.g., a pager number, is then associated with the order to create a queued order. The queued order is then held in a database of the computer-based ordering system. The queued order is released and fulfilled after the queue value has expired.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND ART

1. Field of the Invention

This invention relates generally to computer-based systems used for ordering goods and services. More particularly, this invention relates to coordinated order and delivery of goods and services using self-service terminals and software tools for same.

2. Description of the Related Art

Point of Sale (POS) systems provide a means by which ordering and purchasing transactions can be carried out electronically at the store or other venue where the goods or services are supplied. Many of these POS systems are used by the merchants themselves to consummate transactions with their customers. Other POS systems comprise self-service terminals that can be used directly by the customer to order goods, pay for them, or both. The POS system generally includes at a minimum a processor-based terminal device along with software running on the processor to carry out the functions of the terminal. One or more remote computers are typically connected to the terminal by, for example, a computer network or dialup telephone connection to enable communication between the terminal and computer(s) for the purpose of carrying out the transaction (order, payment, etc.).

Self-service POS systems typically have a central computer acting as a server and one or more terminals which are the individual client units that are used by customers to input their orders. These terminals are often implemented as kiosks mounted to a floor via a base, or to a wall, or located on a counter or other raised surface. Each kiosk will include a computer display screen, possibly speakers for audio output, and one or more input devices such as a keyboard, key pad, or touch sensor overlaying the display screen. When a customer is interested in making a purchase, the kiosk allows customers to select products for purchase from those listed on the screen, submit an order for those products, and, in some cases, pay for the order.

Self-service POS systems typically use a dedicated server to communicate to each self-service client terminal. The server can be a general purpose computer located somewhere on the premises or remotely, and is programmed with software that is used to provide each client with product information for customer ordering. Changes to the products offered via the self-service terminals usually require access to and use of an administration program on the server using common input devices such as a keyboard and mouse to change the product offerings or information about those products (e.g., price).

Self-service POS systems have limitations, however, in that some commercial environments do not lend themselves to being useful. One such environment is the class of restaurant that is commonly referred to as a “sit-down” restaurant or a “casual dining” restaurant. A self-service POS system does not facilitate the customer or the establishment because a disconnect would occur between the ordering of items by a customer at the self-service POS system and when the customer was seated at a table to be served. Items delivered to the self-service POS system would require the customer to return thereto and claim the food. This is an inconvenience and disruption to the dining experience that would render the self-service POS system of little or no value.

### SUMMARY OF THE INVENTION

A method for ordering goods and services incorporates the use of a computer-based ordering system. The method includes receiving an order for goods or services through the computer-based ordering system to create an order. A queue value is then associated with the order to create a queued order. The queued order is then held in the computer-based ordering system. The queued order is released and fulfilled after the queue value has expired.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 illustrates an exemplary self-service ordering system made in accordance with the invention;

FIG. 2 illustrates an exemplary kiosk of the ordering system;

FIG. 3 illustrates the various software layers running on the client kiosks, client/server kiosk, and central server in the exemplary self-service ordering system;

FIG. 4 depicts a sandwich selection screen provided by the self-order application running on a kiosk in the exemplary self-ordering system;

FIG. 5 depicts a succeeding screen in which a first set of options for a selected sandwich are provided;

FIG. 6 is a logic chart of one embodiment of the inventive method;

FIG. 7 is a second embodiment of the inventive method;

FIG. 8 is a second alternative embodiment of the inventive method; and

FIG. 9 is a second embodiment of a self-service ordering system made according to the second alternative embodiment of the invention.

### DETAILED DESCRIPTION OF THE PREFERRED EMBODIMENT

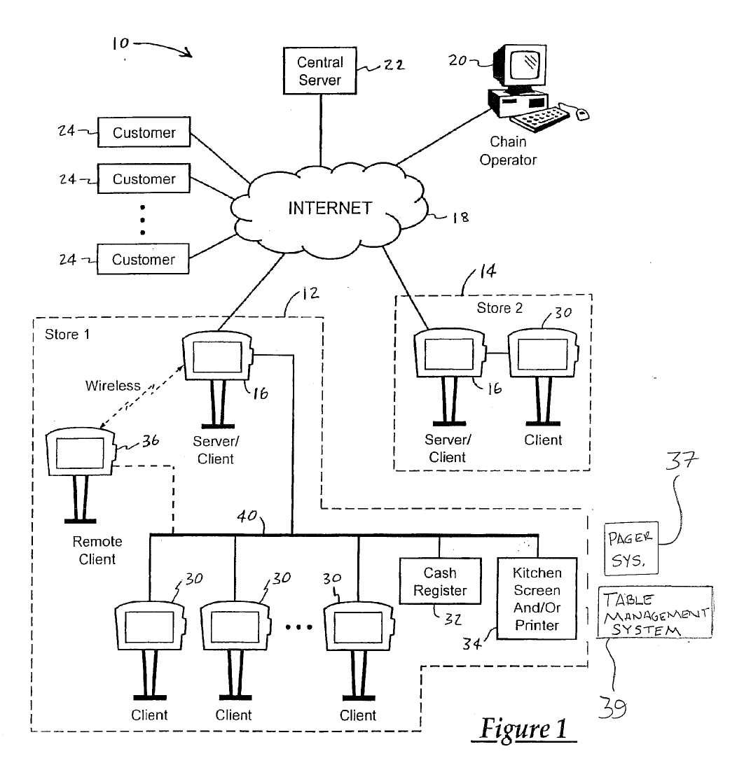

FIG. 1 shows an exemplary self-service ordering system 10 constructed in accordance with the invention as it might be used by a chain of restaurants (or store locations). While a single one restaurant or store location may incorporate the invention, the system 10 shown includes two store locations 12, 14 each having a plurality of kiosks arranged in a client-server configuration. In each store, the local (on-site) server 16 is connected to the Internet 18 which allows remote access by the restaurant chain operator 20 and enables the local server 16 to access a central server 22 for software and media updates. This Internet connection also makes possible use of the local server 16 for receiving online customer orders from customers 24. In general, a single store location will include at least one local server 16 and at least one client kiosk 30. In a more typical configuration such as is shown for Store 1 (store location 12), the store location will include a single server 16, multiple client kiosks 30, a cash register 32 (for cash, credit card, debit card, bar code card, or other payment means), and possibly a kitchen build screen or printer 34 for use by the food preparers in making and/or aggregating the food items for a particular order. The store location might also include one or more remote clients 36 (e.g., for ordering outside the store, but in a nearby location such as a drive-through kiosk, or at a kiosk located elsewhere in the same mall in which the store is located). In the preferred embodiment, the store location will also include a notification system, typically a pager system 37 and a table management system 39. The notification system 37 will notify a customer that is waiting for a table exactly when a table in the store has been made available. The table management system 39 will identify which tables are available and when. Sometimes, the table management system 39 is as simple as a sheet of paper. In other stores or restaurants, the table management system 39 is a sophisticated electronic system of management. In the embodiment shown in FIG. 1, any table management system 39 will suffice.

As indicated in FIG. 1, rather than using a dedicated “back room” computer as the local server, one of the kiosks 16 is used both as a client to permit customer entry of orders and as the local server to interface to the Internet 18 and to respond to requests from the local client kiosks 30. This is accomplished by providing separate client and server software both on a single one of the kiosks 16. The client software allows customer ordering of the food products available at the store. The server software interfaces with the client application on that same kiosk 16 as well as the other local kiosks 30 to provide them with the user interface (e.g., food ordering menus with their graphics and audio), and to receive orders from the client kiosks 30 and supply them to the kitchen screen/printer 34 as well as to the cash register 32 for payment by the customer.

As will be discussed in greater detail below, the client software is a computer program that is accessed by the user via a user interface application written using a multimedia authoring program. For customer ordering of food items, the user interface application is a self-order application that displays a graphic-intensive user interface that allows the customer to select and customize the desired food items, specify quantity, options, etc. Additionally, the local server kiosk 16 further includes an administrative tool comprising a second user interface application that can be accessed by the administrator to perform various administrative functions such as configuring kiosks, creating and editing menus and available food items, and specifying tax and payment features of the system. This administrative tool is also written using a multimedia authoring program that provides an administrative user interface to the client program. During normal use, the server process runs in the background while the food ordering client software application provides the same user interface (screen display, touch screen input) as the other client kiosks 30. When access to server administration is needed, the store owner or other administrator can switch to the administrative tool on the server kiosk 16. As will also be discussed further below, the system also allows the administrative tool to be run from any of the local clients 30, and this can be done, for example, by loading the administrative tool on each client computer 30. Further still, the administrative tool can be employed remotely through a web-based solution that communicates with the kiosks 16, 30 via the Internet 18 or another dedicated network. This is discussed in greater detail below.

The local kiosks 30, cash register 32, and kitchen screen/printer 34 are connected together via a local area network 40 that uses TCP/IP over an Ethernet connection. The remote kiosk 36 can also be hardwired to this LAN 40 or can be connected to the local server 16 or a node on the LAN 40 via a wireless connection. Similarly, any or all of the local client kiosks 30 or other devices at the store location 12 can be connected to the network 40 via a wireless link. The network 40 can be any IP-based network, including LANs, WANs, VPNs, and it will be appreciated that network addressing schemes other than IP can be used. Although not shown, the cash register 32 or another device on the network 40 can be connected to a credit card payment center either via the Internet 18, a telephone connection, or a wireless communication network (e.g., cellular data network) to process customer payments. As indicated in FIG. 1, the second restaurant 14 can have a simple one or two kiosk setup without any of the additional components shown in connection with the first restaurant 12; however, the more typical configuration will include a merchant order processing device such as a cash register 32 and/or display screen/printer 34 for use by the merchant to carry out and complete the transaction.

Although customer orders are typically received via one of the local kiosks 30, the central server 22 can be used to provide a web interface between the customers 24 and local server 16. This enables customers 24 to place orders remotely using a standard web browser. Various suitable ways of implementing online ordering and integration of that into a local ordering system are known to those skilled in the art. Remote access also allows the chain operator 20 to remotely run the administrative tool. This can be done several ways. One is for the chain operator 20 to have the administrative tool loaded on a remote computer. For this, the remote computer can access the configuration information (menu screens, items, and other settings) at the local server 16, then allow the operator to make changes, and then update the local server 16 with the new configuration information. A second approach is to have the administrative tool loaded on the central server 22 and then provide the chain operator 20 with web access to the central server 22. In this approach, the central server 22 then accesses and stores updated configuration information on the local server 16. A third approach is to provide a web interface to the administrative tool on the local server 16 so that the chain operator 20 can access this interface from any Internet connected general purpose computer using the IP address of the local server 16. This can be done using any of a number of different remote access and control approaches known to those skilled in the art. Other means of providing remote administration of the kiosks can be utilized.

As noted above, the central server 22 can be used to provide software and media updates to the local servers 16. Furthermore, the central server 22 can provide additional optional features to the system 10, such as remote diagnostics of kiosks, automated kiosk installations, data repository, centralized reporting, etc. Where no central server 22 is used on the system, remote ordering by customers 24 over the Internet can still be provided by using the local server 16 as a web server configured to allow online ordering.

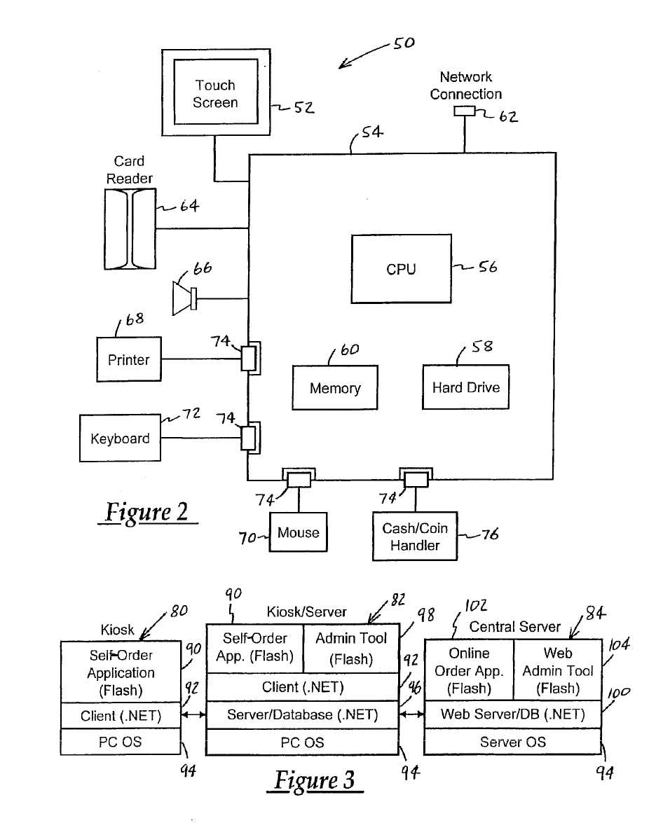

Turning now to FIG. 2, there is shown one embodiment of a kiosk of the ordering system. The kiosk 50 includes most of the elements commonly found in a general purpose computer, including a display screen 52 and motherboard 54 having a central processing unit (microprocessor) 56, hard drive 58, solid state memory 60, and a network connection 62. Connected to the motherboard 54 are the display screen 52, a card reader 64 (e.g., magnetic and/or bar code) for data input, and a speaker 66 for audio output. Other devices such as a printer 68 can be attached or integrated into the kiosk 50. The display screen 52 is implemented as a touch screen that operates as both a display unit and an input device for use by customers and administrators. Other displays and input devices can also be used, such as a standard CRT, LCD, mouse 70, keyboard 72, etc. For this purpose, the motherboard 54 includes additional ports 74 (e.g., USB) for connecting a printer 68, keyboard 72, and mouse 70. While these additional input and output devices can be included as a permanent part of the kiosk 50, the system is designed so that both customer use and administration can be carried out via the touch screen 52 only. Also, as indicated in FIG. 2, a cash handler 76 can be directly connected to the kiosk 50 to carry out validation of the bill and receipt and dispensing of cash. The solid state memory 60 may include RAM, ROM, and/or any other suitable computer-readable memory. The network connection 62 may be implemented using a wireless device for communication through WI-FI, Bluetooth, or other suitable wireless communication protocols, or may include a hardwired connection to a LAN or WAN.

FIG. 3 illustrates the various software layers running on the client kiosks 80, client/server kiosk 82, and central server 84. As mentioned above, in use the client program is accessed via a user interface that is provided using the touch screen to enable customers to use the system. This is carried out using a multimedia authoring tool to develop a graphical user interface application 90 that runs atop a web services layer 92 that provides the underlying client functionality. At the bottom software layer is the base operating system 94, such as Microsoft Windows.™. XP or WePOS. This operating system includes the .NET Framework. VS.NET, ASP.NET and/or Windows Forms are used for programming to provide the basic client functionality. The user interface to this NET application is preferably Macromedia Flash.™. content (e.g., .swf files) or some other enhanced vector graphics file format such as SVG. The use of Flash content developed through, for example, ActionScript and as a graphical user interface to Microsoft.NET programming is known to those skilled in the art. Thus, in the illustrated embodiment, the software stored on each kiosk 80 includes a combination of a client computer program 92 (e.g., written in .NET) and user interface content 90 stored in an enhanced vector graphics file format, with this content being used by a suitable player or virtual machine (e.g., Macromedia Flash Player) to generate the user interface on the touch screen.

For the server kiosk 82, it includes not only the client program 92, but also a server program 96 (including its associated database) as well as an administrative tool 98 for configuring the server program 96. The administrative tool 98 is also implemented through the use of an enhanced vector graphics user interface overlying the Microsoft.NET client program 92 which handles communication between the administrative tool 98 and server program 96. By way of example, a vector graphics presentation layer application such as Microsoft Silverlight™ may be employed. As used herein “enhanced vector graphics” and “enhanced vector graphics file format” refer to files that support either multiple vector graphics (such as are used in displaying animations) and/or single vector graphics in conjunction with other content that can be displayed (e.g., text, video, raster-based graphics) or otherwise supplied (e.g., audio) to the user. Again, SWF and SVG files are two examples of this format. Another suitable format is the XAML format used by Microsoft Windows Presentation Foundation.™., XAML presentations can be generated using the Microsoft Expression Interactive Designer.™. tool. However implemented, the administrative tool 98 can include the same functions typically used to add, delete, and configure kiosks in the system, to make global settings (e.g., set time, sales tax percentage, receipt header and footer text), to create display screens (e.g., food ordering menus), to create a list of food items that are used on the different menu screens, and to edit the various attributes of the food items (e.g., name, associated graphic, price).

In the illustrated embodiment, the administrative tool 98 is not only produced using the combination of enhanced vector graphics content overlying a programming software layer (such as .NET), but the software architecture is used in conjunction with the touch screen of the kiosk to enable complete administration of the system via the local server kiosk, and, if desired, this can be done without the need for additional input devices such as a keyboard or mouse. Thus, the store owner or chain operator can carry out administration of the system using a simplified user interface that requires little if any training or experience with computers. Furthermore, the web services platform provided by .NET can be used to provide remote administration by the chain operator from any Internet-connected computer (such as a home office computer) so that various store locations can be configured from a single computer. The programming needed to implement this software architecture strategy is known to those skilled in the art.

The central server 84 can likewise be implemented using Flash movies or some other enhanced vector graphics files that interface directly to a web server program 100. The central server 84 can include both a web based online order application 102 as well as a web based administration tool 104. Again, the programming used to implement this approach will be known to those skilled in the art.

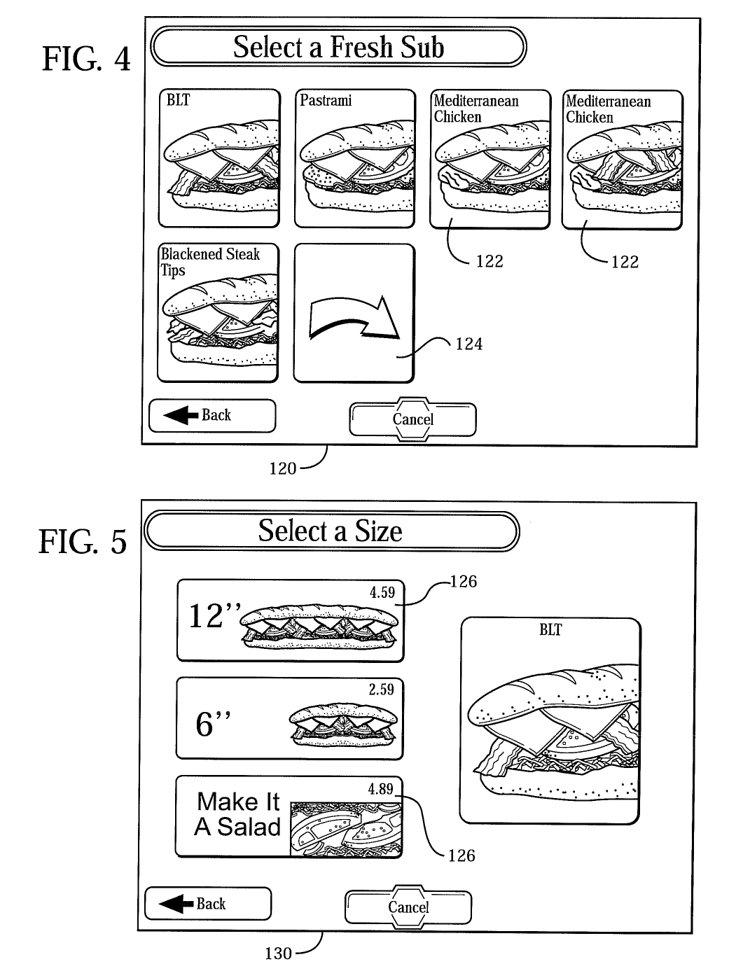

Various features and uses of the self-order application (customer user interface) 90 and the administrative tool 98 used on the kiosks will now be described. The self-order application 90 provides a set of interactive screens that guide the customer through the process of placing an order. The interactive screens contain menus of available items and/or options displayed on the touch screen through the user interface software. For example, FIG. 4 depicts a sandwich selection screen 120 which allows the customer to select (buttons 122) an item (particular type of sandwich) or return (button 124) to the main item ordering menu (not shown) where the different categories of food available are provided (e.g., sandwiches, salads, drinks, side orders, etc.). FIG. 5 depicts a succeeding screen 130 in which a first set of options (buttons 126) for the selected item (BLT sandwich) are provided. On this screen, the customer is able to select the size of the sandwich, or is able to change the sandwich order into a similar type of salad. Note that FIGS. 4 and 5 represent examples of what the screens may show. One skilled in the art may appreciate that there are several other iterations and options available for possible choices and decisions that could be made. For a more complete set of examples, please refer to a United States patent application having publication number 2007/0265935, assigned to a common assignee, and expressly incorporated herein by reference.

Multiple button types are used to guide the customer through different scenarios that may-be encountered during the ordering process. These button types include menu buttons (MenuButton), select one buttons (SelectOne), single modifier buttons (SingleMod), multiple modifier buttons (MultipleMod), select other buttons (SelectOther), quantity buttons (Quantity), less/normal/more buttons (LNM), and none/normal/extra buttons (NNE), each of which are described below. MenuButtons allow the customer to select a category to reach submenus in the system. For example, MenuButtons are used by the customer to select a category of food, such as sandwiches or side order items or drinks. As another example, a menu may ask the customer if they would like to select an additional item when ordering a meal and, for that purpose, the menu includes a MenuButton to allow the customer to decline the offer. Upon selection of a MenuButton, the software navigates to a new screen or submenu to continue the ordering process. SelectOne buttons allow customers to select a single item from a menu, such as a particular sandwich from a sandwich menu, and immediately jump to another menu based on the selection. Thus, SelectOne buttons differ from MenuButtons primarily in that the SelectOne buttons are used by the client software to register the selection of an item or option prior to moving to another display screen, whereas the MenuButtons are used primarily just to navigate to another screen without any selection of an item or option.

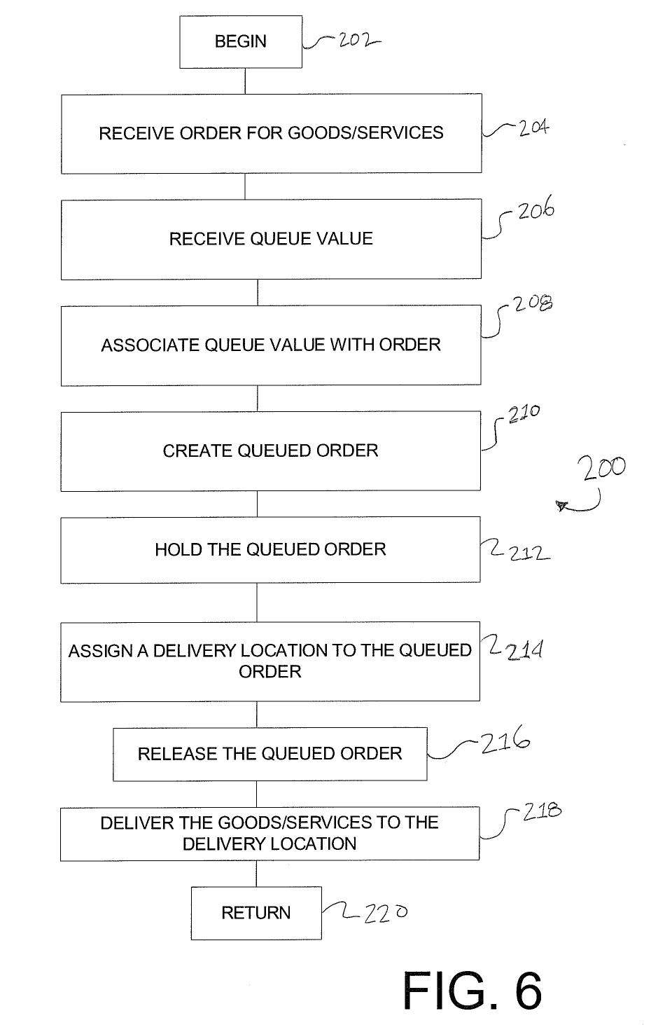

Referring to FIG. 6, a first embodiment of the inventive method is generally indicated at 200. The method is for ordering goods and services using a computer-based ordering system. The method 200 begins at 202. The method 200 receives an order for goods and services at 204. In the embodiment contemplated, the request for goods or services relates to the seating of a party of one or more individuals to be seated and be served food in a casual dining or sit down restaurant. The order is received at the kiosk 30. For the optimal use of the inventive method, the local kiosk 30 is found in a waiting area adjacent a lobby of a restaurant. It is also contemplated that the kiosk 30 could be located in a bar area where patrons of the restaurant could wait for a table to be seated. The individuals of the party input their request or order for food at the kiosk 30 during step 204.

Once the order is entered, a queue value is received from the patrons at 206. A queue value represents the place in which the party is waiting for a table. The queue value may simply be a name given to the host stationed at the lobby of the restaurant. Alternatively, the queue value would be a number associated with a pager that would be handed to the party waiting for the table. It may be appreciated by those skilled in the art that any other type of notification system may be used (e.g., mobile phone number, email address) wherein a queue value is given to a patron to wait in queue for the next available table suitable for their needs. In the case of phone numbers and email addresses, the host station would need access to a network suitable for using these forms of identification for notification.

The method 200 then associates the queue value with the order at 208. A queued order is created at 210. A queued order is an order that is received by the patrons waiting for a table to sit at coupled with the queue value that was given to the patrons by the host of the restaurant.

The queued order is held at 212. More specifically, the queued order is not sent to the kitchen for the preparation of the food at this time. Food preparation is held in abeyance at this time because the patrons have not been seated at their table and could not comfortably consume the food. Likewise, if the food was prepared while they were waiting, it may sit under a hot lamp for a period of time and be consumed later by the patrons when the food is not in its most valuable condition.

Upon obtaining a table or delivery location, the delivery location is assigned to the queued order at 214. At this point, the queued order now includes three pieces of information. The queued order includes the order for the goods received by the patrons of the restaurant. In addition, the queued order has the queue value and the delivery location associated with the order that was placed by the patrons. Once the delivery location has been assigned, the queued order is released at 216. Because the patrons have been seated, the order may be filled at that time. Therefore, the queued order is submitted as soon as the patrons are seated at their delivery location or table and not after they have been waiting for wait staff to take their order after they have seated. This release of the queue order upon identification of the delivery location reduces the cycle time in which a patron is seated at a table and enhances the dining experience of the patron by reducing the time in which the patron has to wait before he or she receives the food that was ordered. Therefore, the economic gain for such a system is two-fold.

Once the queued order is released the goods or services are delivered to the delivery location at 218. The method returns at 220. It should be appreciated by those skilled in the art that the queued order could be modified or augmented while the patrons are seated at the table as it is commonly done. The inventive method 200 is used, however, in the ordering process to synchronize the submission of orders of food to the kitchen with the seating of the patrons at their table.

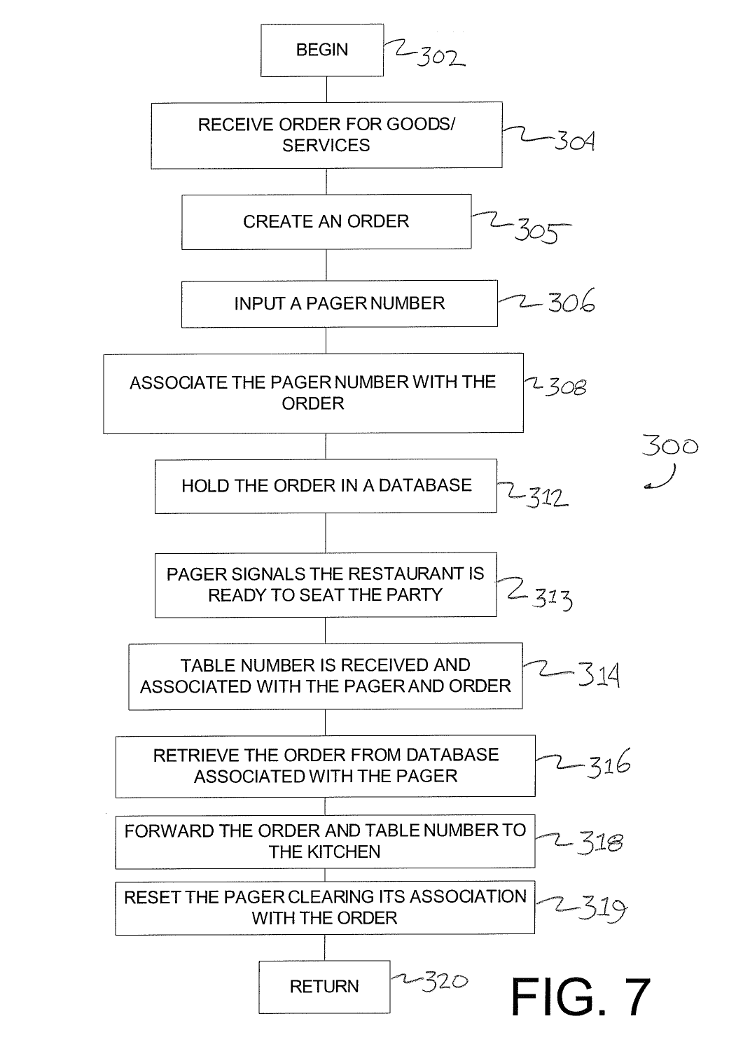

A first alternative embodiment of the inventive method is shown in FIG. 7, wherein similar reference numerals offset by 100 represent similar steps as those discussed above in the first embodiment of the inventive method. In this method, the queue value is created by a pager system. In this embodiment, an order is created at 305 and associated with a pager number at 308. The order is then held in the database at 312. The pager signals that the restaurant is ready to seat the patron at 313. The table number is received and associated with the pager and the order at 314. The association of the table number with the pager and the order can be done in several different manners. First, the table number could be entered into the system manually by the host once the pager is returned by the patron of the restaurant. This could be done by the host station having access to the self-service ordering system, either through a kiosk 30, or by having access to the client software and a network connection to the self-service ordering system. In a second embodiment, each table at the restaurant may have a docking station at the table. The pager could be inserted into the docking station upon their arrival at the table. Once the pager is docked, it communicates back with a table management system 39 which identifies where that particular pager has been docked and sends that information to the system in the local kiosk 30 such that the delivery location of the food ordered by that particular patron is coupled with the order and delivered to the appropriate table. Alternatively, the pager number may be input into a table management system by the host upon the pager being returned thereto. This would be a partially automated system in that the table management system would then be coupled with the system in the local kiosk 30 and deliver the information about the delivery location for a particular pager to the local kiosk 30 such that the delivery location would be coupled to the order so that when the food is prepared, the destination of the food is known. Once the pager is identified with an associated delivery location, the pager is cleared of its association with the order at 319. The method returns at 320.

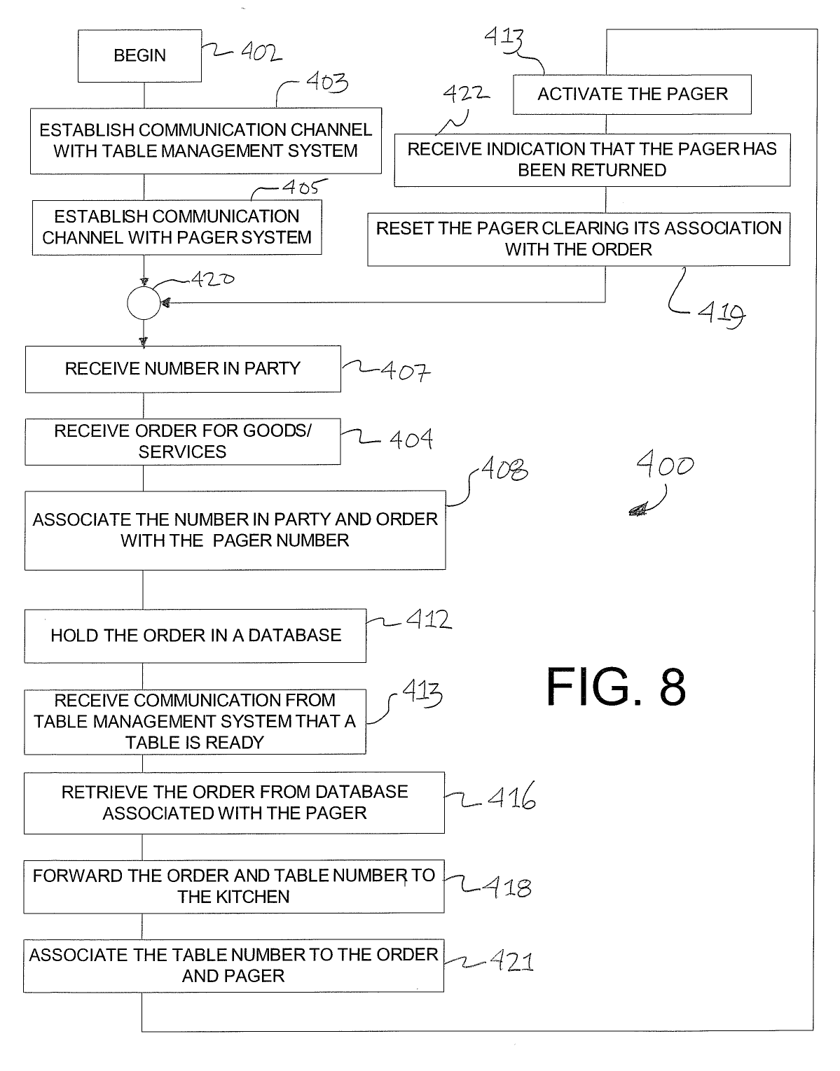

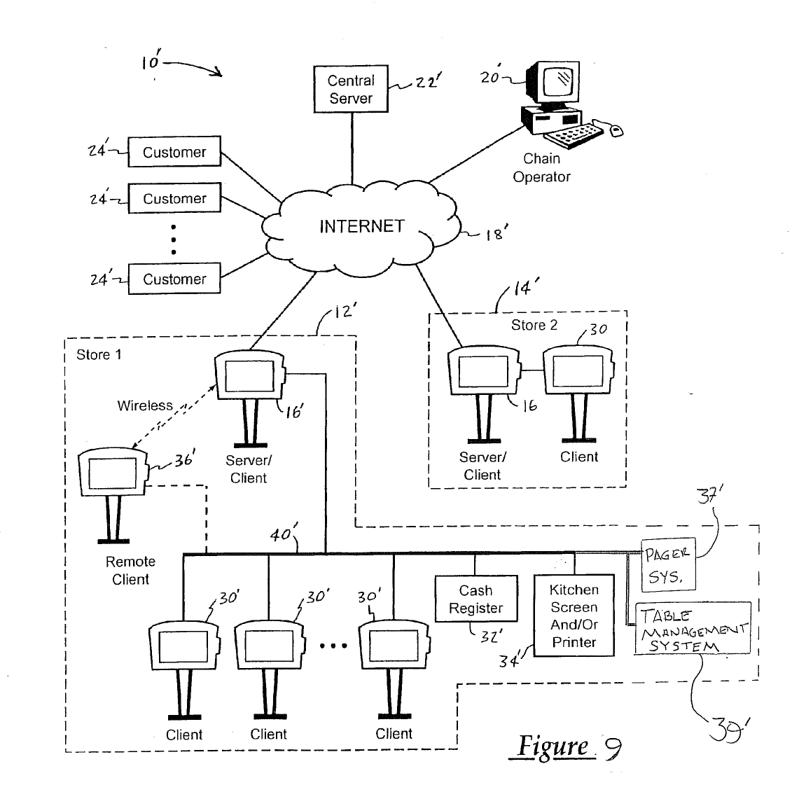

Referring to FIGS. 8 and 9, a second alternative embodiment of an inventive method and system are generally shown. The inventive method shown in FIG. 8 has elements offset by 100 from those of the first alternative embodiment. With specific reference to FIG. 9, like prime reference numerals represent identical elements as those discussed above with reference to FIG. 1. The second alternative embodiment of the inventive method 400 begins at 402. The system establishes a communication channel with the table management system at 403. The system also establishes a communication channel with the pager system at 405. Once these communications channels have been made, the system in the local kiosk 30′ receives a number identifying the number of patrons in a particular party at 407. The order of goods and/or services is entered then at 404. The number in the party and the order are then associated with a pager number at 408. The completed order including the number in the party, and the order, and the pager number are held in a database at 412.

The local kiosk 30′ receives communication from the table management system 39′ that a table is ready at 413. The table management system 39′ would identify a table as being ready to receive new patrons upon its being cleared by a busboy or other such wait staff. When a particular table is identified as being cleared that information is sent to the system in the local kiosk 30′ and retrieves the oldest order queued in the system that includes the number of patrons which equal the capacity at that particular table. By way of example, if a table is made available that can seat six, the oldest order queued that is associated with a party of six will be retrieved. Therefore, even though a party of four may have been waiting longer, the party of six will be seated and the order will be pulled out of the database as soon as the table is identified as being made available.

Once the order is retrieved the table number is associated to the order and the pager at 421. Once the table number is associated with the pager, the pager is activated to signal the party that the restaurant is ready to seat them at 413. Once the pager is returned or docked at 422, the pager is reset clearing its association with the order at 419. The system then returns to receive the next order and party number at 420.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for ordering goods and services using a computer-based ordering system, the method comprising the steps of:
receiving a request for goods or services through the computer-based ordering system to create an order;
associating a queue value representing a place in a queue with the order to create a queued order;
holding the queued order preventing fulfillment thereof; and
releasing the queued order for fulfillment after the queue value has expired.

2. A method as set forth in claim 1 including the step of assigning a delivery location to the queued order.

3. A method as set forth in claim 2 including the step of delivering the goods and services to the delivery location to complete the order.

4. A method as set forth in claim 3 including the step of using a paging system to create the queue value.

5. A method as set forth in claim 4 including the step of using a table management system to complete the step of assigning the delivery location.

6. A method as set forth in claim 5 wherein the step of releasing the queued order includes the step of assigning a pager number to the delivery location.

7. A method as set forth in claim 6 wherein the step of assigning the pager number to the delivery location includes the step of docking a pager at the delivery location.

8. A method for ordering goods and services using a computer-based ordering system, the method comprising the steps of:
receiving a request for goods or services through the computer-based ordering system to create an order;
associating a queue value representing a place in a queue with the order to create a queued order;
holding the queued order preventing fulfillment thereof;
assigning a delivery location to the queued order; and
releasing the queued order for fulfillment after the delivery location has been assigned.

9. A method as set forth in claim 8 including the step of delivering the goods and services to the delivery location to complete the order.

10. A method as set forth in claim 9 including the step of using a paging system to create the queue value.

11. A method as set forth in claim 10 including the step of using a table management system to complete the step of assigning the delivery location.

12. A method as set forth in claim 11 wherein the step of releasing the queued order includes the step of assigning a pager number to the delivery location.

13. A method as set forth in claim 12 wherein the step of assigning the pager number to the delivery location includes the step of docking a pager at the delivery location.

14. A method as set forth in claim 12 wherein the step of assigning the pager number to the delivery location includes the step of entering the pager number into a table management system.

15. A method as set forth in claim 14 including the step of querying the table management system for the delivery location associated with pager number.

16. A method as set forth in claim 15 including the step of receiving a party number quantifying a number of persons associated with the order.

17. A method as set forth in claim 16 including the step of releasing the queued order after the table management system identifies a delivery location suitable for a queued order based on the party number associated with the queued order.
